(19) United States
(12) Patent Application Publication
(10) Pub. No.: US 2014/0362697 A1
(43) Pub. Date: Dec. 11, 2014

(54) PROCESS FOR MANAGING A QUEUE OF DATA

(71) Applicant: Christophe DESNOYER, Davron (FR)

(72) Inventor: Christophe DESNOYER, Davron (FR)

(21) Appl. No.: 14/295,732

(22) Filed: Jun. 4, 2014

(30) Foreign Application Priority Data
Jun. 6, 2013 (FR) 13 55230

(51) Int. Cl. H04L 12/863; H04L 29/08

(52) U.S. Cl. CPC H04L 47/625; H04L 67/16; H04L 67/02
USPC 370/230.1

(57) ABSTRACT

Method for managing a queue of data sent by a requesting data processing system (2) to a target data processing system (1), comprising, subsequent to the sending of the data capable of being added to the queue:
a transmission by the target system (1) of said data and of a signal regarding placement on hold comprising an authorization criterion to be satisfied defined by the target system (1), the signal regarding placement on hold being able to control the execution of a method of placement on hold,
an implementation of said method of placement on hold by the requesting system (2) from the receipt of the signal regarding placement on hold until the authorization criterion is satisfied,
a processing by the target system (1) of the data sent by the requesting system (2) once the authorization criterion has been satisfied.

The invention relates to the management of a queue of computer data in particular in a system for exchanging computer data, on an Internet site, or in a telecommunication system.

The invention deals in particular with the problem of congestion of Internet sites, but may also be applied to the problems of congestion in a telecommunication system or any other exchange of computer data where the streams must be regulated.

Like any place that accommodates visitors, be they virtual or physical, an Internet site possesses an accommodating capacity limited by the technical and/or financial implementational resources. As the crowds of visitors on the Internet site cannot be controlled directly by the site, the latter is liable to undergo saturation.

The saturation of an Internet server gives rise to a slowdown in the flowrate of data on the Internet site which may give rise to an absence of response of the Internet site to an internet user client attempting to access the Internet site, or even an erroneous response. This absence of response or these erroneous responses may cause serious harm or problems in the case of uncompleted transactions, of deliveries without receipt of payment for example.

In the cases of real places accommodating physical visitors such as shops, museums, or stadiums for example, a solution exists making it possible to regulate the traffic and to tailor the crowds to the accommodating capacity of the place: queues.

A queue is generally a tangible or intangible structure of one or more entries and of one or more exits intended to store tangible or intangible entities, the entry accepting these entities without limitation other than a possible limit storage capacity, exit from the queue being authorized only as a function of a quota, for example a constant or variable number of exits per time unit, imposed on account of the capacity of that to which the waiting list affords access, exit of these entities occurring in order of entry or any constant permutation of the order of entry, with or without priority, and whether this order is complied with in a guaranteed or approximate manner.

In this sense, the term queue covers any of a queue, a waiting list, a waiting room, a storage area, a buffer area, a buffer, or a stack structure, inter alia, with or without priority.

So-called “total knowledge” queues exist, in which the position of everyone in the queue is known perfectly. This is the type of queue used in particular at the cinema or in a medical center for example. If anyone abandons their place and leaves the queue, the next person will advance one position just like all the other people following. The queue is self-regulated by the collaboration between the people waiting, or else it is regulated by a third-party authority that knows where everyone is in the queue, as is the case for example in a waiting list of passengers in case of overbooking of a transport means.

So-called “partial knowledge” queues also exist, implemented for managing queues of physical people. In these types of queues, no one knows the exact order, but everyone has information making it possible to know when their turn has arrived. This type of queue is used in particular in shops or administrations using a queue organized on the basis of numbered tickets. Everyone is then free to come and go as they desire, or indeed to go away and come back just in time when their turn has arrived. The queue is thus regulated by a third-party authority, a regulating system, that distributes and verifies the numbered tickets.

In the virtual world inhabited by Internet sites, such solutions do not work since they are prone to two problems: list cramming and exhaustion of resources.

The first problem, spamming or spamming, is a phenomenon which is manifested in the following manner during an exchange of data of computer type such as on the Internet: since the visitors wishing to access the Internet site are virtual, it is possible to create “ghost” visitors, that is to say phantom visitors not representing a real physical client using a computer or any other type of device accessing the Internet. These “ghost” visitors, although not representing a real person, are present in the queue to access the Internet site and occupy a place for nothing in the queue; a genuine internet user, that is to say a physical person, situated in the queue behind thousands of ghost internet users, then no longer has any chance of accessing the Internet site.

These “ghost” entities which congest the queue to access the Internet site or a page of the Internet site may be created unintentionally. Such is the case for example when an internet user clicks again on a link or a button making it possible to access the desired page of the Internet site because he has the impression that the previous request has not been taken into account. As many phantom additional access requests, and therefore “ghost” visitors, are created as times the internet user has clicked on the link or the button.

“Ghost” entities may also be created en masse and maliciously so as to render the site inaccessible in practice without it even being necessary to saturate it. Queues susceptible to list cramming can therefore be blocked yet more easily than the site that they are aimed at protecting. This is why they are rarely implemented.

The second problem, the exhaustion of resources, occurs in respect of total-knowledge queues when there are too many requests to access an Internet site for the means implementing the queue to be able to store them all.

In respect of partial-knowledge queues, the means implementing the queue must either retain permanent communication with each entity placed on hold so as to call it in its turn, thereby consuming resources, storage resources in particular, for each one, or grant each one a reserved interlude to allow it to enter once its turn has arrived, before passing to the next. In both cases, there is therefore allocation of resources, temporal or memory, and therefore risk of saturation of these resources.

Methods of queue management for physical persons are known in particular from the documents U.S. Pat. No. 4,398,257, U.S. Pat. No. 5,502,806, U.S. Pat. No. 5,987,420, U.S. Pat. No. 6,329,919, U.S. Pat. No. 6,529,786 and U.S. Pat. No. 6,889,098.

Also known from document U.S. Pat. No. 6,947,450 is a method for managing a computer data queue in which various degrees of priority are given to the data in the queue, which does not make it possible to solve the problems mentioned hereinabove.

The invention proposes a method of queue management for computer data using an unordered, zero-knowledge queue to reduce the problems of exhaustion of resources, and a computing challenge mechanism to reduce spamming problems.

According to one aspect of the invention, it is proposed a method for managing a queue of data sent by a requesting data processing system to a target data processing system, comprising, subsequent to the sending of the data capable of being added to the queue:
a transmission by the target system of a signal regarding placement on hold comprising an authorization criterion to be satisfied defined by the target system, the signal regarding placement on hold being able to control the execution of the method of placement on hold defined hereinbelow,
an implementation of said method of placement on hold by the requesting system from the receipt of the signal regarding placement on hold until the authorization criterion is satisfied,
a processing by the target system of the data sent by the requesting system once the access authorization criterion has been satisfied.

The target system does not thus manage any queue directly and does not store any information relating to the requesting system or to any order, the holding wait being implemented on the requesting system by itself.

Preferably, before said transmission, the target system generates an identifier transmitted with the signal regarding placement on hold and intended to be stored by the requesting system and returned by the requesting system when re-sending the data.

In this method of access request queue management, each of the entities placed on hold has only one item of information, the identifier, but is ignorant of the position of the others. An entity corresponds to a requesting system that has sent an item of data, for example an item of computer data or an access request, intended for the target system which may be an Internet site. Each entity placed on hold is even ignorant of its own position in the queue. Even the target system is ignorant of which entities are waiting and what their position is.

The method of queue management according to the present invention is said to be “unordered” and “zero knowledge” queuing.

Such a method then ensures a mean equity between the entities on hold by complying with the length of time that the request has spent waiting in the queue and not its position.

It does not maintain the state of the queue and therefore the latter may have any size, without any physical limit.

The identifier is stored solely by the requesting system so that the target system does not congest its means for storing this information.

Preferably, the identifier comprises a time-stamped element. The time-stamped element comprises the date and the time of generation of the signal regarding placement on hold by the target system.

When it is again presented to the target system, this time-stamped element allows the target system to determine the time elapsed since the first sending of the data by the requesting system to the target system.

The time-stamping, together with the realization of the authorization criterion, makes it possible to immunize the method of queue management against the saturation of the resources.

When the authorization criterion is satisfied, the target system preferably verifies the identifier associated with the data re-sent by the requesting system and the satisfaction of the authorization criterion, the target system processing the data re-sent by the requesting system if the authorization criterion is satisfied and if the verified identifier corresponds to an identifier generated and transmitted initially by the target system.

The verification of the identifier and of the satisfaction of the authorization criterion by the target system makes it possible to avoid malicious acts due for example to the repeated generation of identical data by a requesting system, the identifier making it possible to ensure that the target system has already placed the data of the requesting system in the queue, and the satisfaction of the authorization criterion making it possible to ensure that the requesting system has indeed carried out a job of work equivalent to waiting on hold for a certain time and thus to avoid the data being returned with no interlude.

Advantageously, the authorization criterion comprises a holding time determined and adapted by comparing the flowrate or the actual speed of exit of the data from the queue with the setpoint respectively of flowrate or of speed of exit of the data from the queue.

The holding time required can be computed and regulated as a function of the actual exit flowrate of the queue compared with the flowrate setpoint, or as a function of the inverse quantities that is to say of the mean interlude between two consecutive actual exits and of the setpoint of the interlude between two exits. These two points of view, with respect to the speed and to the interlude between two exits, are equivalent and interchangeable.

The method for regulating the holding time can be heuristic.

Thus, if the actual exit flowrate is greater than the flowrate setpoint, this means that the holding wait is insufficient, in which case the holding time is increased, for example linearly by adding a constant quantity to it.

If, on the other hand, the actual exit flowrate is less than the flowrate setpoint, this means that the holding wait is excessive, in which case the holding time is decreased, for example exponentially by reducing it by a certain percentage.

The regulation of the holding time can also be carried out according to a proportional integral regulation or a derived proportional integral regulation on the basis of the error signal consisting of the discrepancy between the actual flowrate and the setpoint flowrate or their inverse quantities.

These various schemes for regulating the holding time may also be combined. Depending on situation, the heuristic scheme or the direct computation of the holding time may be used.

In addition to the holding time, the authorization criterion may advantageously comprise a stochastic fit with a stochastic formula of the following form for example:

If, although the holding time is sufficient, x)e^{-K(A-T)} then access authorization can be accepted, otherwise the request is placed back on hold for a new holding time.

With x a pseudo-random number included in the interval [0; 1[; K is a constant, A is the actual holding time in the queue corresponding to the time elapsed since the time-stamping, and T is the determined holding time.

This variant makes it possible to regulate the determined holding time T to a level less than the actual holding time since the age condition A>T becomes necessary but not sufficient, and therefore to offer the requesting systems placed on hold a chance to benefit from a future decrease in the holding time. This improves the equity between the requesting systems.

Preferably, between the verification of the identifier and of the authorization criterion by the target system and the processing of the data by the target system, the following steps are carried out:
a) the target system determines a new holding time,
b) if the new holding time is less than the actual holding time corresponding to the time elapsed since the time-stamping, the target system processes the data re-sent by the requesting system,
c) otherwise the data are returned to the requesting system (2) with a holding signal comprising a holding time that is equivalent to the difference between the new holding time computed in step a) and the actual holding time.

Steps a) to c) make it possible to prolong the placement on hold of a requesting system when access to the target system cannot yet be authorized.

Advantageously, the authorization criterion can comprise a computing challenge, also called proof of work, the requesting system furthermore transmitting, once the authorization criterion has been satisfied, the determined solution of the computing challenge to the target system, and the verification by the target system that the authorization criterion is satisfied comprising the verification of the solving of the computing challenge.

The authorization criterion can thus comprise both a technical challenge to be solved and a holding time, or else just one of the two conditions.

As already mentioned, the phantom so-called “ghost” entities can be created intentionally also, maliciously. For example, to block access to the Internet site or indeed to cause damage to it. In the latter case, one speaks of “service denial” attacks.

The queuing method is the best solution for regulating traffic by ensuring equity. But, in order for this method to be usable on the

Internet, in a system for exchanging telecommunications data, or in a system for data exchanges where a problem of spamming exists, it is necessary to render the queuing method insensitive to “ghost” entities, that is to say to immunize it against “spam”.

The solving of a challenge by the computing system requesting access to the target computing system makes it possible to immunize the queuing method against spam.

Advantageously, the identifier can furthermore comprise a unique identification element and/or an element specific to the requesting system.

The unique identification element makes it possible to differentiate for example two placements on hold having the same time-stamping.

The identifier can furthermore comprise an element specific to the requesting system. The element specific to the requesting system makes it possible to relate each identifier to the requesting system and to avoid possible reproduction of an identifier already used by another requesting system. The element specific to the requesting system can be the IP (Internet Protocol) address of the browser or be related to this IP address.

The identifier can also comprise an electronic signature dependent on the elements constituting the identifier.

The electronic signature makes it possible to attest to the authenticity of the identification element and in particular of the indication of the date and of the time of receipt. The electronic signature can consist of a cryptographic method, with a public or secret key or a digest including a secret element.

Advantageously, the target system can also preserve a sample of limited size of the list of the latest identifiers used or of a random choice from among the latest identifiers used. Thus, even if a requesting party reuses massively an identifier from a client computer, it will be detected and its IP address will be excluded from authorization and excluded from the queue.

The steps carried out by the target system that differ from the processing of the data by the target system can advantageously be implemented by regulating means disposed at the input of the target system.

Thus the part of the target system specific to the processing of the data sent does not process the data until after the authorization has been validated by the regulating means.

In a variant, the signal regarding placement on hold can comprise a redirection of the requesting system to an auxiliary system which transmits to the requesting system a computer program comprising software code portions for the execution of said method of placement on hold.

According to another aspect of the invention, there is proposed a computing system comprising means configured to implement the method of queue management defined hereinabove.

According to yet another aspect of the invention, there is proposed a computer program product loadable directly into a memory of a computing system, comprising software code portions for the execution of the method of queue management defined hereinabove when said program is executed on said computing system.

According to yet another aspect of the invention, there is proposed a system readable by a computing system, having computer-executable instructions adapted for effecting the execution by the computing system of the method of queue management defined hereinabove.

The invention also proposes a method of placement on hold of a processing of data by a target data processing system until an authorization criterion defined by the target system is satisfied, the method being intended to be implemented on a requesting data processing system that has sent the data to be processed by the target system.

According to a general characteristic of the invention, the requesting system sends said data to the target system again, once the authorization criterion is satisfied.

Preferably, the authorization criterion comprises a holding time. The requesting system thus resends the data to be processed by the target system on expiry of the holding time.

Advantageously, the access authorization criterion can comprise the solving of a computing challenge by the requesting system.

The requesting system can advantageously display a holding page until the authorization criterion is satisfied. The display of a holding page by the requesting system makes it possible to notify the user of the requesting system of the placement on hold of the processing, as well as of the end of this holding wait.

Advantageously, the display of a holding page comprises a periodic message loading. The periodic message loading thus makes it possible to modify and to vary the messages displayed on the requesting system destined for the user so as to reduce the waiting sensation.

The holding page preferably displays elements comprising advertising messages provided by an advertising computing system.

According to another aspect of the invention, there is proposed a computing system comprising means configured to implement the method of placement on hold defined hereinabove.

According to yet another aspect of the invention, there is proposed a computer program product loadable directly into a memory of a computing system, comprising software code portions for the execution of the placement on hold management method defined hereinabove when said program is executed on said computing system.

Other advantages and characteristics of the invention will be apparent on examining the detailed description of an embodiment and of a mode of implementation, wholly non-limiting, and the appended drawings in which:

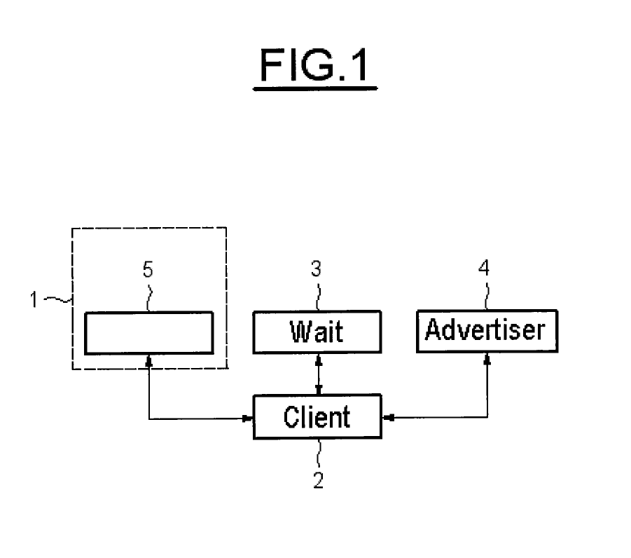

FIG. 1 presents, in a schematic manner, a computing system configured to implement the method of queue management according to an embodiment of the invention;

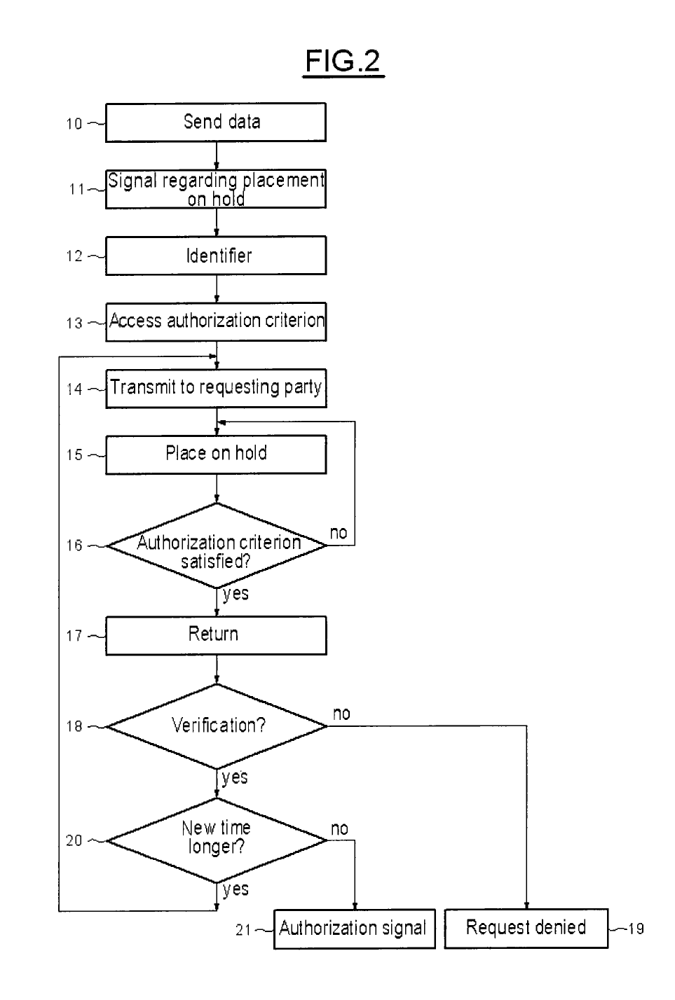

FIG. 2 schematically presents a schematic of a method of queue management according to a mode of implementation of the invention;

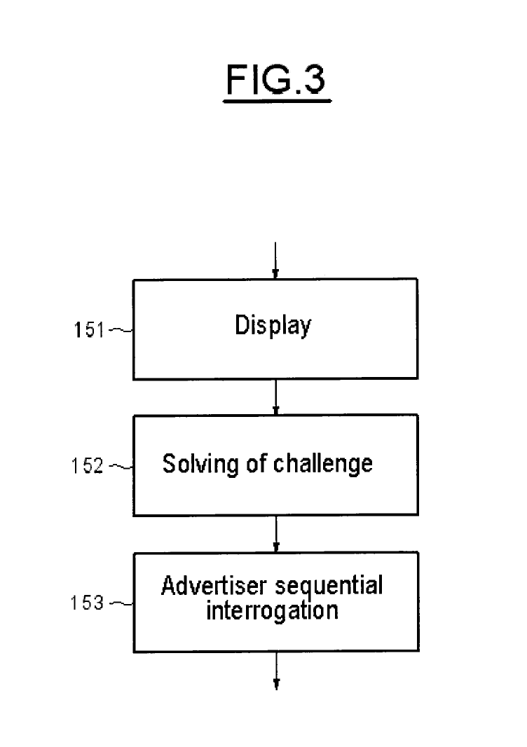

FIG. 3 schematically presents a detail of the placement on hold step 15 according to a mode of implementation of the invention.

Represented in a schematic manner in FIG. 1 is a computing system configured to implement the method of queue management for data sent by a requesting computing system 2, or client, to a target computing system 1 according to an embodiment of the invention. In this embodiment the data sent by the requesting system 2 correspond to a request for access to an Internet site or a page of an Internet site implemented by the target system 1.

FIG. 2 is a schematic of a method of queue management according to a mode of implementation of the invention, the method being implemented by the system of FIG. 1.

In a first step 10, a client commands a requesting computing system 2 such as a computer connected to the Internet to send a request for access to an Internet site or a page of an Internet site implemented on the Internet by the target computing system 1 which may be an Internet server.

The target system 1 comprises, in this embodiment, regulating means 5 at input able to manage the access request stream at input.

Thus, if the regulating means of the target system 1 are overloaded by a large number of requests for access to the Internet site and cannot authorize access to the page straight away, the regulating means 5 of the target system 1 generate, in a step 11, a signal regarding placement on hold to be transmitted to the requesting system 2, as well as, in a step 12, an identifier comprising a unique identification element, the IP address of the requesting system 2, a time-stamping, that is to say the date and the time of generation of the identifier, and an electronic signature. In a step 13, the regulating means 5 also generate an access authorization criterion.

In a following step 14, the identifier and the authorization criterion are transmitted with the signal regarding placement on hold by the regulating means of the target system 1 to the requesting system 2 which stores the identifier so as to be able to represent it to the target system 1 after the access authorization criterion has been processed.

The unique identification element and the IP address of the requesting system included in the identifier make it possible to relate each identifier to the requesting computing system and to avoid possible reproduction of one and the same identifier.

The IP address of the requesting system being transmitted moreover on account of the very nature of the network exchanges between the requesting system 2 and the target system 1, it will not need to be repeated explicitly in the identifier, while implicitly forming part thereof.

The electronic signature included in the identifier makes it possible to attest to the authenticity of the identifier, and in particular the date and time indicated. The electronic signature can consist of a cryptographic method, with a public or secret key, or of a digest comprising a secret element.

In this embodiment, the target system 1 does not preserve any identifier in memory.

The authorization criterion comprises a holding time and a computing challenge that the requesting system 2 must solve during the placement on hold.

The holding time is determined by the regulating means 5 of the target system 1 by measuring the actual exit flowrate of the queue at the level of the regulating means 5 and by comparing it with the flowrate setpoint.

The holding time is regulated in a heuristic manner by increasing it linearly when the actual exit flowrate is greater than the flowrate setpoint, thus signifying that the duration of hold is insufficient. The holding time is on the contrary decreased exponentially when the actual exit flowrate is less than the flowrate setpoint, thus signifying that the duration of hold is excessive.

Alternatively, this regulation of the holding time is coupled with a regulation of Proportional Integral or Proportional Integral Derivative type.

The solving of a computing challenge by the requesting system 2 makes it possible to immunize the method for managing the queue against spam. Phantom entities may indeed be created accidentally or else intentionally, maliciously, giving rise to spam of the computing system implementing the method for managing the queue.

The solving of a challenge by the computing system 2 requesting access to the target computing system 1 makes it possible to immunize against spam the method of queue management according to the invention.

The computing challenge consists of a problem to be solved by the requesting computing system 2 during the placement on hold. The access authorization criterion remains invalidated as long as the computing challenge is not solved by the requesting system 2.

The challenge can be compared to a crossword grid to be solved during a placement on hold. The computing challenge generated by the target system 1, and more particularly in this embodiment by the regulating means 5 of the target system 1, requires a significant computational load on the part of the requesting system 2.

In a step 15, the requesting system 2 is thus placed on hold. In this embodiment and mode of implementation, the placement on hold is managed by a script transmitted by a placement on hold system 3, or garage system. The signal regarding placement on hold transmitted by the regulating means 5 of the target system 1 comprises a redirection of the requesting system 2 to the placement on hold system 3 which then transmits to the requesting system the script comprising the lines of codes allowing the implementation of a method of placement on hold on the requesting system 2.

In a variant, the script can already be loaded into the requesting system 2, the method of queue management not requiring in this case redirection and communication with the placement on hold system 3.

FIG. 3 details the placement on hold step 15. On receipt of the script by the requesting system 2, the script generates the display of a holding page in a step 151. The display page to be displayed is sent by the placement on hold system 3 in the example illustrated.

At the same time, the requesting system carries out, in a step 152, the automatic processing of the computing challenge. The computation to solve the challenge is thus performed automatically by the script. The computation is split up into as many fragments as is required to preserve the fluidity and reactivity of the holding page displayed. If necessary, if the browser of the requesting system 2 allowing the generation of the holding page applies a script execution time quota, these computation segments are scheduled by periodic calling of the computation function.

The solving of the challenge thus occurs in a manner transparent to the client, or internet user, and does not interfere with the animation of the placement on hold.

The computational load needed to solve the challenge, although representing several tens of processor seconds, is painless for the requesting system 2 which waits expectantly for authorization to access the target system 1. Indeed, instead of doing nothing else during the placement on hold than displaying the holding page, the browser of the requesting system 2 executes computations to solve the challenge.

On the other hand, for a requesting system whose objective is to “spam” the target system 1 and to cause list cramming and which places on hold thousands of phantom entities a second, this computational load is prohibitive. It cannot cram the queue with thousands of phantom entities a second and fulfill the challenge of each, except by having tens of thousands of processors in parallel. This is what renders its spamming action inoperative and renders the queue immunized against spam.

A computing challenge can consist of the solving of the following problem. Determine four characters, denoted XXXX, from among a fixed set of 64 characters, so that the digest of the message composed of XXXX followed by the content of the remainder of the identification element begins with 20 zero bits.

Thus, on average 2²⁰, i.e. about 1 million, computation iterations are necessary in order to solve the problem, which on an office computer or on a modern mobile terminal and according to the best software implementations in an Internet browser, requires some thirty or so seconds of computation.

The display of the holding page makes it possible to carry out simultaneously with the solving of the challenge, in a step 153, an animation of the placement on hold of the client which consists in exploiting this holding wait, where the internet user has to monitor whether or not it has terminated, to display one or more information messages, fixed or animated with images, videos, sound and/or other multimedia. These messages have a fixed or variable duration and are strung together automatically without intervention of the internet user.

These messages can be directly related to the holding wait, or propose alternative solutions to the holding wait, or of a commercial nature for one's own account or pure advertisement, or serve some other communication objective. The insert or inserts where these messages are displayed are clickable, making it possible to access a page, open in addition to the holding page, chosen by the advertiser, the disseminator of the message. The objective of the animation is to capture the attention of the internet user client, to sustain his motivation to access what follows the wait and to shorten his perception of the duration of hold.

This animation is established by dispatching for the duration of the placement on hold the messages to be displayed on the holding page of the browser of the requesting system from an advertising computing system 4 such as an advertising server by a communication channel between the holding page and this server.

The advertising server 4 may be distinct from the placement on hold server 3 and/or from the target server 1, or else one and the same. It may be operated by the Internet site implemented by the target system 1 or by a third party.

The exchanges of computer data consist in communicating to the holding page the message to be displayed or instructions prescribing the message to be displayed as well as the duration of display. The holding page displayed on the requesting system 2 also informs the advertising server 4 when a message has been displayed completely, thus making it possible to detect the premature abandonments due to a closing of the page, of the browser or the like.

In a following step 16, the requesting system 2 detects the satisfaction of the authorization criterion, namely the solving of the computing challenge and the expiry of the holding time defined initially by the regulating means 5 of the target system 1. As long as the access authorization criterion is not satisfied, that is to say as long as the challenge is not solved and/or the holding time has not expired, the placement on hold in step 15 is prolonged.

Once the authorization criterion has been satisfied, the placement on hold is ended without any intervention of the internet user and the requesting system 2 returns to the target system 1 the data, namely in this example a request for access to the Internet page, accompanied by the identifier and by the satisfied authorization criterion.

The regulating means 5 of the target system then verify, in a step 18, that the authorization criterion has indeed been satisfied, on the one hand, and that the identifier is correct, on the other hand.

If the authorization criterion is not satisfied or the identifier is not recognized, the authorization request is refused in a step 19, since it originates from an unknown source for example.

On the other hand, if the authorization criterion is indeed satisfied, in this embodiment and mode of implementation, on receipt of this new request, the regulating means 5 of the target system 1 determine, in a step 20, a new placement-on-hold time.

This new placement-on-hold time is compared with the total actual holding time that the requesting system has already waited. The actual holding time is determined on the basis of the date and time indicated in the identifier.

If the new placement-on-hold time is less than the actual holding time, the regulating means 5 of the target system 1 send, in a step 21, a signal for authorization of access to the target system 1 which transfers the requesting system 2 to the target system 1 and authorizes the request for access of the requesting system 2 to the target system 1 and the processing of the data.

If on the other hand in the meantime the holding time has increased and the new holding time is greater than the previous holding time, we recommence from step 14 with a new holding time for the authorization criterion that is equivalent to the difference between the new placement-on-hold time and the corresponding actual holding time elapsed since the time-stamping indicated by the identifier.

This therefore makes it possible to prolong the placement on hold of a requesting system 2 when access to the target system 1 cannot yet be authorized.

Thus the holding time demanded does not change, whatever number of phantom entities are trying to cram the queue.

In this embodiment, the return to step 14 is carried out without new computing challenge to be solved, the return signal comprising the solved computing challenge.

In this schematic illustrated in FIGS. 2 and 3, the method of placement on hold, implemented in the course of the method of queue management, comprises steps 15 to 17 of FIG. 2, step 15 comprising steps 151 to 153 illustrated in FIG. 3.

Thus the method of queue management makes it possible to grant or deny exit from the queue as a function only of length of time spent in the queue, indicated by the date and time in the identification element. Thus, compliance with the order of arrival is not guaranteed absolutely, but is so on average. At a given instant t, if two entities having arrived at moments t₁ and t₂, t₂ being later than t₁, ask to exit the queue, the entity that arrived at the instant t₁ has more chance of obtaining an access authorization than the entity that arrived at the instant t₂ later than t₁. As none knows its own position in the queue nor that of the others, the cases where equity is not complied with do not pose any problem to those that are wronged.

The placement on hold system decides to grant or deny authorization of access to the target system by maintaining and updating an estimation of the time that it will have had to wait.

The method of data queue management can also be applied in the telecommunications sector to the regulation of the traffic entering a router, for example.

In such a case, explained hereinbelow, the requesting system then corresponds to an item of terminal network equipment, such as a computer, generating network data packets to be routed, optionally assisted by an intermediate item of equipment relaying these data. This requesting system is hereinafter dubbed “the source”.

The target system is the router, optionally assisted by a regulating device to which this function is entrusted. This target system is hereinafter dubbed “the router”. The data sent by the source to the router then correspond to a network data packet to be routed.

When a network packet may not be processed immediately by the router, the router sends to the source as a single network data packet a signal regarding placement on hold comprising the network data packet placed on hold, an authorization criterion associated with the network data packet, and an identifier comprising a time-stamping of the initial request, a unique identification element and an electronic signature.

Next, the source performs the actions necessary to fulfill the authorization criterion which comprises the waiting of a prescribed interlude determined as described in the previous example, and the solving of a challenge.

Next, the source returns the network data packet while adding thereto the identifier provided and the solution of the proposed challenge.

The router then verifies, on the one hand, that the identifier presented is not falsified on the basis of its electronic signature, and, on the other hand, that it is not reused by virtue of the IP (Internet Protocol) address of the source and by virtue of the random sample of the latest identifiers used, and if the request is thus invalid, it is rejected definitively.

Subsequently, the router verifies the solution of the challenge and if it is incorrect, it returns the network data packet for a complementary holding interlude.

The router again determines the holding time prescribed as described previously, and then if the total holding wait of the network data packet (including possible returns to hold) exceeds this time, the router accepts the network packet.

Otherwise, if the total holding wait of the request does not exceed this time, the router retransmits the network data packet to the source with a new prescribed holding interlude.

In this mode of implementation it is possible to include in the initial return to hold authorization criterion a prescribed holding interlude, or else to omit it, it being possible for the time required to solve the proposed challenge to suffice. This inclusion decreases the probability of a second return to hold on completion of this initial holding wait.

It is also possible to include in the authorization criterion a challenge to be solved, this inclusion making it possible to differentiate legitimate requests from artificial requests or spam.

The identifier can also comprise a unique identifier, this uniqueness being a necessary prerequisite for detecting reuses of identification elements, it being possible for two distinct requests to have the same time-stamping.

The identifier can also comprise in this mode of implementation of the method of data queue management, an electronic signature, so as to allow the detection of possible falsifications of the identification elements, and in particular of their time-stamping.

Furthermore, the electronic signature can include an element specific to the source system such as its IP address, this inclusion making it possible to detect reuses of identifiers in the particular case where a requesting system reuses an identifier belonging to another requesting system.

It is also possible for the target system to preserve a random sample of certain of the latest identifiers used, this preservation making it possible to detect reuses of identification elements.

Moreover, in this particular mode of implementation, the return of the network data packet with the signal regarding placement on hold is advantageous although optional, this return avoiding the need for the network data packet to have to be kept in memory by the source in possible expectation of this signal coming back, this being particularly advantageous in the telecommunications sector.

1. Method of placement on hold of a processing of data by a target data processing system (1) until an authorization criterion defined by the target system (1) is satisfied, the method being intended to be implemented on a requesting data processing system (2) having sent the data to be processed by the target system (1), characterized in that the requesting system (2) sends said data to the target system (1) again, once the authorization criterion has been satisfied.

2. Method according to claim 1, in which the authorization criterion comprises a holding time.

3. Method according to claim 1, in which the authorization criterion comprises the solving of a computing challenge by the requesting system (2).

4. Method according to claim 1, in which the requesting system (2) displays a holding page until the authorization criterion is satisfied.

5. Method according to claim 4, in which the display of a holding page comprises a periodic loading of messages.

6. Method according to claim 4, in which the holding page displays elements comprising advertising messages provided by an advertising computing system (4).

7. Method for managing a queue of data sent by a requesting data processing system (2) to a target data processing system (1), comprising, subsequent to the sending of the data capable of being added to the queue:
a transmission by the target system (1) of a signal regarding placement on hold comprising an authorization criterion to be satisfied defined by the target system (1), the signal regarding placement on hold being able to control the execution of a method of placement on hold according to claim 1,
an implementation of said method of placement on hold by the requesting system (2) from the receipt of the signal regarding placement on hold until the authorization criterion is satisfied,
a processing by the target system (1) of the data sent by the requesting system (2) once the authorization criterion has been satisfied.

8. Method according to claim 7, in which, before said transmission, the target system (1) generates an identifier transmitted with the signal regarding placement on hold and intended to be stored by the requesting system (2) and returned by the requesting system when re-sending the data.

9. Method according to claim 7, in which the identifier comprises a time-stamped element.

10. Method according to claim 8, in which, when the authorization criterion is satisfied, the target system (1) verifies the identifier of the data re-sent by the requesting system (2) and the satisfaction of the authorization criterion, the target system (1) processing the data re-sent by the requesting system (2) if the authorization criterion is satisfied and if the verified identifier corresponds to an identifier generated and transmitted initially by the target system (1).

11. Method according to claim 7, in which the authorization criterion comprises a holding time determined and adapted by comparing the flowrate or the actual speed of exit of the data from the queue with the setpoint respectively of flowrate or of speed of exit of the data from the queue.

12. Method according to claim 9, in which, between the verification of the identifier and of the authorization criterion by the target system (1) and the processing of the data by the target system (1), the following steps are carried out:
a) the target system (1) determines a new holding time,
b) if the new holding time is less than the actual holding time corresponding to the time elapsed since the time-stamping, the target system (1) processes the data sent by the requesting system (2),
c) otherwise the data are returned to the requesting system (2) with a holding signal comprising a holding time that is equivalent to the difference between the new holding time computed in step a) and the actual holding time.

13. Method according to claim 7, in which the authorization criterion comprises a computing challenge to be solved by the requesting system (2), the requesting system (2) furthermore transmitting, once the authorization criterion has been satisfied, the determined solution of the computing challenge to the target system (1), and the verification by the target system (1) that the authorization criterion is satisfied comprising the verification of the solving of the computing challenge.

14. Method according to claim 8, in which the identifier furthermore comprises a unique identification element and/or an element specific to the requesting system (2).

15. Method according to claim 8, in which the identifier furthermore comprises an electronic signature dependent on the elements constituting the identifier.

16. Method according to claim 8, in which the target system (1) preserves a sample of limited size of the latest identifiers used or of a random choice from among the identifiers used.

17. Method according to claim 7, in which the steps carried out by the target system (1) that differ from the processing of the data by the target system (1) are implemented by regulating means (5) disposed at the input of the target system (1).

18. Method according to claim 7, in which the signal regarding placement on hold comprises a redirection of the requesting system (2) toward an auxiliary system (3) which transmits to the requesting system (2) a computer program comprising software code portions for the execution of said method of placement on hold.

19. Method according to claim 9, in which the authorization criterion furthermore comprises a stochastic fit according to the mathematical expression:
If, although the holding time is sufficient, x)e^{-K(A-T)} then access authorization can be accepted, otherwise the request is placed back on hold for a new holding time, with “x” a pseudo-random number included in the interval [0; 1[, “K” a constant, “A” the actual holding time in the queue corresponding to the time elapsed since the time-stamping, and “T” said determined holding time.

20. Computing system comprising means configured to implement the method according to claim 1.

21. Computer program product loadable directly into a memory of a computing system, comprising software code portions for the execution of the method according to claim 1 when said program is executed on said computing system.

22. Computing system comprising means configured to implement the method according to claim 7.

23. Computer program product loadable directly into a memory of a computing system, comprising software code portions for the execution of the method according to claim 7 when said program is executed on said computing system.

24. Medium readable by a computing system, having computer-executable instructions adapted for effecting the execution by the computing system of the method according to claim 7.
